(19) United States
(12) Patent Application Publication
(10) Pub. No.: US 2004/0128391 A1
(43) Pub. Date: Jul. 1, 2004

(54) Method and system for managing a validity period in association with a presence attribute

(76) Inventors: Robert Patzer, Lake Zurich, IL (US); David Boldt, Arlington Heights, IL (US); Bin Hu, Mountain View, CA (US); Dmitri Latypov, San Mateo, CA (US)

Correspondence Address: MOTOROLA INC, 600 NORTH US HIGHWAY 45, ROOM AS437, LIBERTYVILLE, IL, 60048-5343, US

(21) Appl. No.: 10/334,875

(22) Filed: Dec. 31, 2002

(51) Int. Cl. G06F 15/16; G06F 12/14; H04L 9/32; G06F 11/30

(52) U.S. Cl. 709/228; 709/250; 713/200

(57) ABSTRACT

A method and presence attribute information server is provided for managing a validity period in association with a presence attribute. The presence attribute information server includes a processor, an interface unit, and a storage unit. The interface unit is coupled to the processor, and includes a network interface for receiving and transmitting user presence attribute information. The storage unit is coupled to the interface unit and the processor, and includes presence attribute information organized and arranged as one or more entries in a data structure. Each presence attribute information entry has an identifier field identifying the type of presence attribute, a presence attribute value field, and a validity period field. In at least one embodiment, the presence attribute information is maintained as an application being executed as part of a user device, where the interface unit additionally includes a data input device for receiving user attribute information from the user.

### FIELD OF THE INVENTION

The present invention relates generally to the management of a user's presence attributes, more particularly, to the management of a validity period defining the time period during which the presence attribute is valid.

### BACKGROUND OF THE INVENTION

Presence attributes are presently used as a way to define, manage and convey a user's relationship relative to a communication network. Present definitions allow for several different types of information to be managed, including a user's geographical location, a user's on-line status and a user's availability. Presence attributes have even been discussed as a means to manage, record and convey a user's present mood. The nature of the presence attributes are such, that they are likely to change over time. However, it is not always known whether the presently recorded information is current, or when the information was last updated. Consequently, the certainty with which one can rely upon the accuracy of the information is sometimes difficult to determine.

In some instances, the user may need to maintain the accuracy of the information. In these instances, a person's ability or willingness to maintain the information is critical to insuring the present accuracy of the information. In other instances, it is possible for the network to monitor and update the relevant information, for example, as to the on-line status of a user. In these instances, concerns as to the accuracy of the information are minimized.

Presence information has historically been used in instant messaging type applications. In at least some instances, an instant messaging system will allow a buddy list to be maintained, which can alert a user as to the on-line status of a predefined subset of users, even when a user is not actively attempting to communicate with an individual on the buddy list. A user's geographic information, in addition to a user's on-line status, may be further beneficial. A user may be able to determine that an individual they want to talk to is only a short distance away, making it equally convenient to discuss a matter in person.

Location information may also be useful in dispatching emergency personnel to the location of an emergency, like an accident, as it may help to identify which personnel are already located within the proximity of the scene of an accident. Alternatively, a courier service may be able to better schedule a package pick-up, if it knows where its drivers are presently located. Sometimes the availability of accurate presence attribute information may be sufficient to satisfy another user's inquiry. For example, the presence attribute defining a user's present geographical location, may answer another user's question, as to whether an individual has already left work for the day, and/or whether he is on his way home.

However, the information is only useful to the extent that it is reliable. Presence attributes are only current as to the last time they were updated, which may have been some time ago, and if one is unable to determine the last time the information was updated, then it may be difficult to ascertain the degree to which one can rely upon the information.

The present inventors have recognized that it would be beneficial to be able to define a period during which presence attributes are valid. In this way, the presence attributes will naturally expire, when they are no longer valid reducing the doubt as to the reliability of the present value of the presence attributes. Furthermore, the defined expiration of presence information may enable the system to more readily determine when it is appropriate to prompt a user to supply updated information, that is anticipated to be no longer valid.

### SUMMARY OF THE INVENTION

The present invention provides a presence attribute information server for managing a validity period in association with a presence attribute. The presence attribute information server includes a processor, an interface unit, and a storage unit. The interface unit is coupled to the processor, and includes a network interface for receiving and transmitting user presence attribute information. The storage unit is coupled to the interface unit and the processor, and includes presence attribute information organized and arranged as one or more entries in a data structure. Each presence attribute information entry has an identifier field identifying the type of presence attribute, a presence attribute value field, and a validity period field.

In at least one embodiment, the validity period field includes a validity duration and an indication when the presence attribute value field was last changed.

In at least a further embodiment, the validity period field includes a time value corresponding to when the information contained within the presence attribute value field is no longer current.

In a still further embodiment the presence attribute information is maintained as an application being executed as part of a user device, where the interface unit additionally includes a data input device for receiving user attribute information from the user.

The present invention further provides a method of managing a validity period in association with a presence attribute. The method includes receiving a user presence attribute information entry including an identifier field identifying the type of presence attribute, a presence attribute value field, and a validity period field. A determination is then made as to a time value when the information contained within the presence attribute value field is no longer current. The determined time value is then compared to the current time. The value of the presence attribute is then updated, if the current time is after the determined time value when the information contained within the presence attribute value field is no longer current.

These and other features, and advantages of this invention are evident from the following description of one or more preferred embodiments of this invention, with reference to the accompanying drawings.

### BRIEF DESCRIPTION OF THE DRAWINGS

FIG. 1 is a block diagram of an exemplary communication network;

FIG. 2 is a block diagram of a presence attribute information server, in accordance with at least one embodiment of the present invention;

FIG. 3 is a block diagram of a presence attribute information manager application incorporated as part of a user device, in accordance with at least one aspect of the present invention;

FIG. 4 is a diagram of a presence attribute information entry, which forms at least part of a data structure maintained by either the presence attribute information server, illustrated in FIG. 2, or a presence attribute information manager application, illustrated in FIG. 3;

FIG. 5 is a portion of a table including one or more user presence attribute authorization entries; and

FIG. 6 is a flow diagram of a method for managing a validity period in association with a presence attribute, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

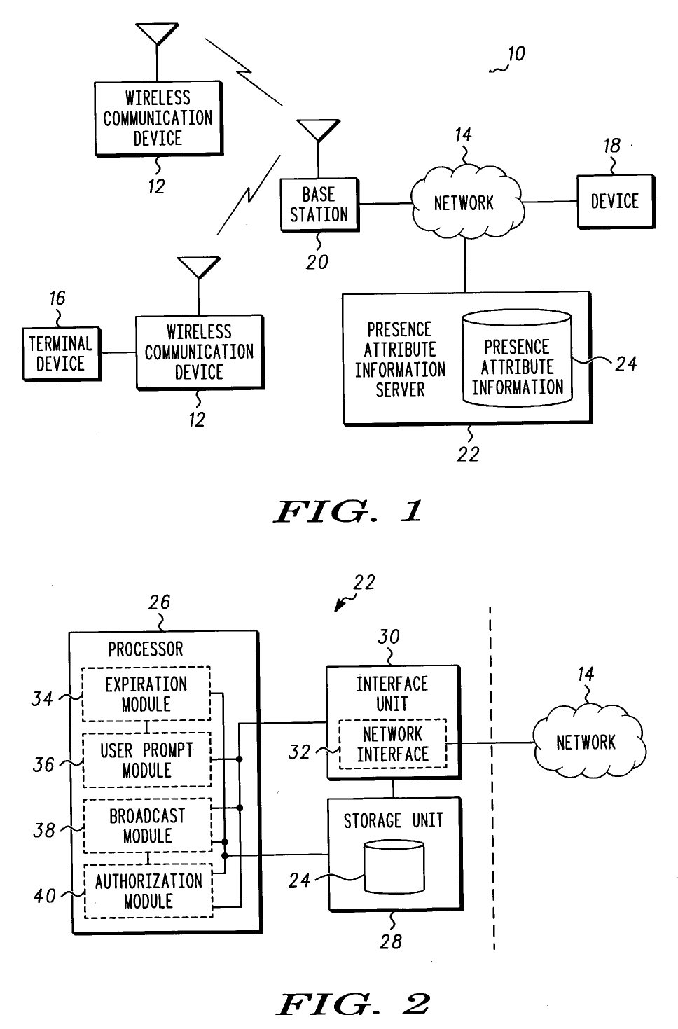

FIG. 1 illustrates a block diagram of an exemplary communication network 10 including a pair of wireless communication devices 12, which separately communicate within the network. The wireless communication devices 12 can be any suitable device capable of communicating over a wireless connection within a network, for example one or more of the wireless communication devices could be a wireless radio telephone, such as a cellular telephone. Alternatively, the wireless communication device could incorporate a wireless LAN connection, a short range radio transceiver, such as a Bluetooth transceiver, an infra-red communication transceiver, or other similar communication device not constrained by a physical wired connection.

The wireless devices 12 in some instances may be self contained and operate independently. In other instances, the wireless communication device will couple to a terminal device 16, and will facilitate the terminal device communicating with the network 14. At least some wireless communication devices 12 will couple to the network 14 via a base station 20, or other type of wireless transceiver, which is physically coupled to the network 14 via a wired connection.

The network 14 may include any type of network that is capable of sending and receiving communication signals. In at least one embodiment, the network 14 includes a wireless communication network. The network 14 may also include or be in communication with a data network, such as the Internet, an Intranet, a local area network (LAN), a wide area network (WAN), a cable network, and other like communication systems. The network 14 may also include or be in communication with a telecommunications network, such as a local telephone network, long distance telephone network, cellular telephone network, satellite communications network, cable television network and other like communications systems. Furthermore, the network 14 may include or be in communication with more than one network and may include a plurality of different types of networks. Thus, the network 14 may include or be in communication with a plurality of data networks, a plurality of telecommunications networks, a combination of data and telecommunications networks and other like communication systems.

The exemplary communication network can additionally include devices, which are coupled to the network via a wired connection, like a personal computer. For example, the personal computer can be coupled to the network via a dial-up modem or a cable modem connection. Additionally coupled to the network are various servers, which supply various types of information, such as web pages, internet address to domain name translations, and the like. In some instances, the servers supply user accessible content, which is of direct interest to the user. In other instances, the servers supply information useful in managing the operation of the network.

In at least one embodiment of the present invention a presence attribute information server 22 is provided. In the illustrated embodiment the server is coupled to the network via a wired connection, however, it is also possible for the server to support a wireless connection to the network. The presence attribute information server supports a data structure 24 including user presence attribute information for one or more users in the form of one or more presence attribute information entries.

Generally, the presence attribute information includes the name or type of presence attribute that the entry corresponds to, and a value for the type of presence attribute. In accordance with the present invention, the presence attribute additionally includes a validity period field. The validity period defines the time period during which the value of the presence attribute is valid. This enables a user to have a higher degree of confidence in the information that is received, and/or can be used by the network to make decisions concerning the management of the presence attribute information. For example steps can be taken to obtain more current information, when a determination is made that the presently provided presence attribute information is no longer valid.

As noted above, presence attribute information has been previously used in association with at least instant messaging type services, and has potential applicability to other network services. The presence attribute information provides information as to a user's relationship relative to a communication network 14. However in some instances, it might not be desirable to make the information, generally available. The information can sometimes be private, or a user may not want the information to be generally known. Consequently, in some instances, access to the information can be generally restricted, or restricted in certain circumstances. Alternatively, authority or permission to access the information might be required. It may also be desirable to limit the level of detail of the information that is available on a per user basis.

While, in some instances, it may be practical and/or desirable to maintain the presence attribute information, centrally, as part of a presence attribute information server, in other instances, it may be desirable to maintain the information as part of a presence attribute information manager application, which is executed as part of an individual user's device.

FIG. 2 illustrates a block diagram of a presence attribute information server 22. The presence attribute information server 22 includes a processor 26, a storage unit 28, and an interface unit 30. The storage unit 28 includes a data structure 24, which has user presence attribute information for one or more users in the form of one or more presence attribute information entries. The storage unit could include both volatile and non-volatile forms of memory, many types of which are well known. One such example includes a fixed drive or hard drive, which commonly stores information magnetically. However any form of data storage may be suitable, so long as it supports the ability to store, update and retrieve the information in the data structure.

In the illustrated embodiment, the storage unit is coupled to both the processor 26 and the interface unit 30. By being coupled directly to the interface unit, it is possible for inquiries to be made of the data stored in the storage unit, which could be accomplished using a form of direct access, without placing any substantial additional burden on the processor 26. However, it is also possible, in one or more alternative embodiments, for the data access to be generally facilitated exclusively by the processor 26.

In the illustrated embodiment, the interface unit 30 includes a network interface 32, which facilitates communication of the server 22 with the network 14.

The processor 26 includes several modules, which in connection with the illustrated embodiment, are in the form of one or more sets of prestored instructions, which are executed by the processor. An expiration module 34 includes a clock (not shown), which maintains the current time. The expiration module 34 interfaces with the storage module 28 and compares the current time with the time at which the presence attribute information is set to be no longer valid. If the presence attribute information is no longer valid, the expiration module 34 can update the presence attribute value field to reflect the expired status.

In the illustrated embodiment, the processor additionally includes a user prompt module 36, which is coupled to the expiration module 34 and the interface unit 30. The user prompt module 36 is adapted to request updated presence attribute information from the user, if the existing presence attribute information is determined to no longer be current.

A broadcast module 38, which is coupled to the interface unit and the storage unit, is adapted to transmit updated user presence attribute information to interested and authorized users. A user can be identified as being interested by subscribing to a particular user's presence attribute information.

An authorization module 40, which is coupled to the interface unit and the storage unit includes a comparator for comparing the identity of a user requesting presence attribute information with the identity of the users that are authorized to have access to the information. In the illustrated embodiment, the users that are authorized to have access to a particular user's presence attribute information are identified by one or more authorization entries associated with the presence attribute entry containing the presence attribute information that is being requested. It is possible that some users might be expressly authorized by an authorization entry to access the presence attribute information. In other instances some users may be expressly denied access by an authorization entry to the presence attribute information. It is additionally possible that multiple levels of access may be possible. For example, different levels of access may produce presence attribute information with varying degrees of granularity/accuracy.

Different levels of granularity, associated with the geographic location of a user, may in one instance provide information as to the city in which the user is located. At an alternative granularity level, the geographic location of a user may provide the street address of a particular building, where the user is located.

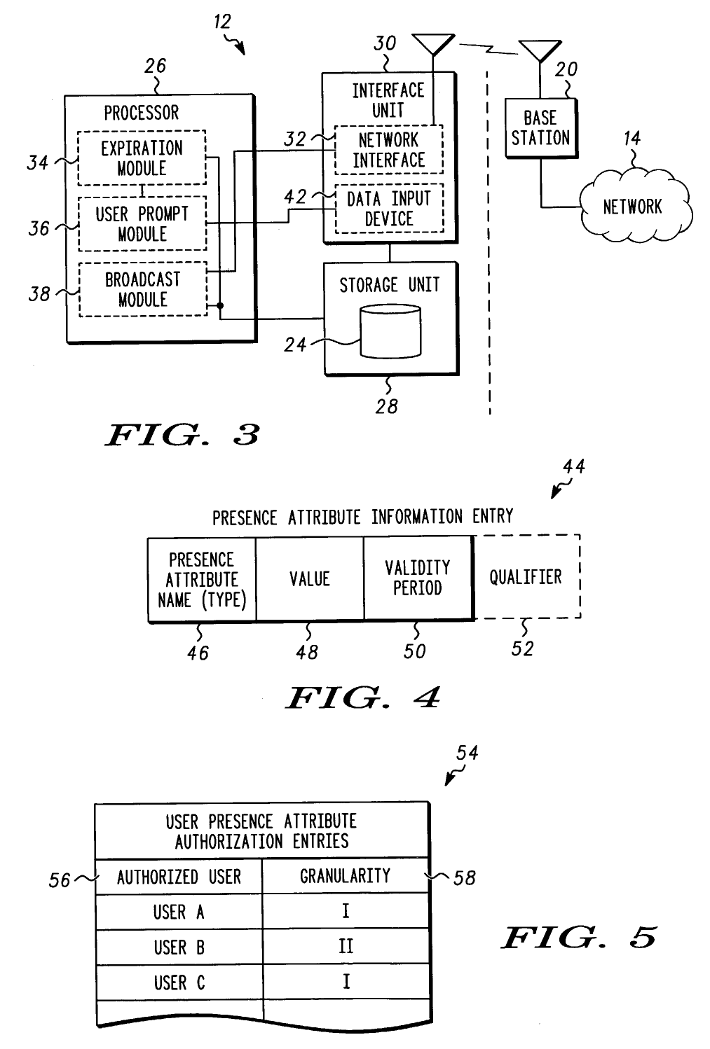

FIG. 3 illustrates a block diagram of a presence attribute information manager application, which is executed as part of an individual user's device. In this instance, it is possible that the individual user's device may function like a server, and gather and provide presence attribute information for multiple users. However it is also possible that the individual user's device is only interested in maintaining its own presence attribute information, and forwards the same to a server for general access by other users to the information.

In at least one embodiment, the user's device is executing a presence attribute information manager application. Several of the functions performed by the presence attribute information manager application are similar to functions already described in connection with FIG. 2 and the presence attribute information server. In addition to performing several functions, which are similar to the functions performed by the presence attribute information server, the user device additionally receives presence attribute information directly from the user. In order to accommodate direct entry of presence attribute information, the user's device, illustrated in FIG. 3, includes an interface unit that includes a data input device 42. The data input device could include any standard form of input such as a keypad or a touch sensitive screen (not shown). In other instances, the data input device could include a mouse or a microphone. One skilled in the art will recognize that other data input devices are also possible, without departing from the teachings of the present invention.

In the embodiment illustrated in FIG. 3, the user device is a wireless communication device 12, such as a cellular telephone. In this instance the device couples to the network, via a base station 20, and a wireless communication channel.

While the present invention has generally been described in association with a wireless communication device, like a cell phone, radiotelephone, or a cordless telephone, one skilled in the art will readily recognize that the invention is suitable for use with other types of devices, where it would be beneficial to manage and/or maintain user presence attribute information. A couple of additional examples of other types of devices, where the use of the present invention would be suitable include paging devices, personal digital assistants, portable computers, pen-based or keyboard-based handheld devices, remote control units, an audio player (such as an MP3 player) and the like.

FIG. 4 illustrates at least one embodiment of a presence attribute information entry 44. In the illustrated embodiment, the presence attribute information entry 44 includes a presence attribute name or type 46, a presence attribute value 48, and a presence attribute validity period 50. The presence attribute name could identify any one of several predefined types of presence attribute information including a user's geographical location, a user's on-line status and a user's availability. Other types of presence attribute information are additionally possible. Depending on the type of presence attribute information, the value field 48 may include different subsets of various types of value information.

A validity period 50 can be a time value, which defines the point in time when the information contained within the presence attribute value field 48 is no longer current. Alternatively, the validity period 50 can include a validity duration. Where a validity duration is identified, it may be additionally beneficial to identify when the presence attribute value field was last changed relative to the specific validity duration. A duration value could be stored as a number of seconds, a number of minutes, a number of hours, etc., or any combination thereof. In this instance, a time value identifying the point in time, when the presence attribute information is no longer valid can be determined by adding the validity duration to the time that the corresponding presence attribute was last set.

The presence attribute information entry 44 could also include a qualifier 52, which might operate as a flag as to the continued validity of the presence attribute information entry. This would allow an entry for a presence attribute information entry, which has lapsed, to be preserved, while still identifying the present attribute as having lapsed. This reduces the risk that the lapsed presence attribute would be erroneously identified as corresponding to current presence attribute information. In this way a history of past values can be preserved.

As noted above, each presence attribute information entry 44 can be associated with one or more user presence attribute authorization entries 54. Each authorization entry can either expressly authorize access, or expressly deny access. In the illustrated embodiment, the authorization entry expressly authorizes access to the presence attribute information of a particular user. More specifically, the authorized user 56 is identified, as well as the authorized level of granularity 58 of the information they are authorized to receive. As noted previously, in connection with geographical location presence attribute information, a first level of granularity 58 might identify the city in which the user is located, while a second level of granularity 58 might identify the street address at which the user is located.

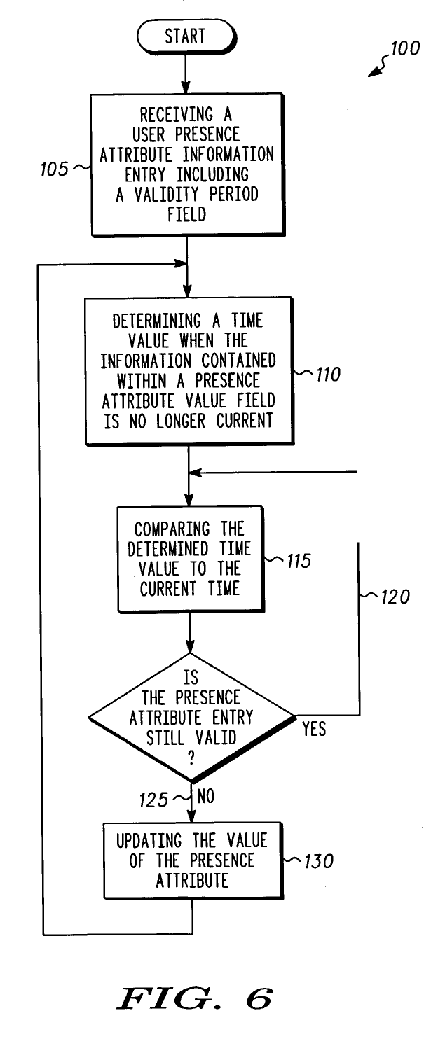

FIG. 6 illustrates a flow diagram 100 of a method for managing a validity period in association with a presence attribute, in accordance with at least one embodiment of the present invention. The method includes receiving 105 a user presence attribute information entry, which includes an identifier field 46 identifying the type of presence attribute, a presence attribute value field 48, and a validity period field 50. A determination 110 is then made as to a time value, when the information contained within the presence attribute value field 48 will no longer be current.

The determined time value is then compared 115 to the current time. If the presence attribute entry is still valid 120, then the method continues to compare the determined time value at which the presence attribute entry will no longer be valid to the current time. If the presence attribute entry is no longer valid 125, then the value of the presence attribute is updated 130. After the value of the presence attribute is updated 130, a determination 110 is then made of a new time value, when the information contained within the presence attribute value field is no longer current.

Updating the value of the presence attribute can include prompting the user for updated presence attribute information, and then using any received new user presence attribute information to update the presence attribute information. Updating the value of the presence attribute can additionally, or alternatively include identifying the validity of the presence attribute information as having lapsed or expired, if the presence attribute information is determined to be no longer current and no subsequent updated information has been received.

When the presence attribute information is updated, changed or modified, the information may be broadcasted to users who are subscribed and/or interested in receiving the information, and who are authorized to received the information. Authorization can be determined as noted above.

In addition to, or as an alternative to, broadcasting the presence attribute information updates, a particular user who is interested in another users presence attribute information can make a specific request for the information (i.e poll the server). In these instances, knowing ahead of time the duration for which the presence information is valid can facilitate determining the point in time at which the user should poll the server next for any updated information.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A presence attribute information server comprising:
a processor;
an interface unit, coupled to the processor, including a network interface for receiving and transmitting user presence attribute information;
a storage unit, coupled to the interface unit and the processor, including presence attribute information organized and arranged as one or more entries in a data structure, each presence attribute information entry having an identifier field identifying the type of presence attribute, a presence attribute value field, and a validity period field.

2. A presence attribute information server in accordance with claim 1 wherein the validity period field includes a validity duration and an indication of when the presence attribute value field was last changed.

3. A presence attribute information server in accordance with claim 1 wherein the validity period field includes a time value corresponding to when the information contained within the presence attribute value field is no longer current.

4. A presence attribute information server in accordance with claim 1 further comprising an expiration module, coupled to the storage unit, the expiration module including a clock, which maintains the value of the current time, the expiration module being adapted to compare the value of the current time with the value of the validity period field to determine if the presence attribute information is current, and, if necessary, updates the presence attribute value field.

5. A presence attribute information server in accordance with claim 4 wherein the expiration module includes a set of prestored instructions for execution by the processor.

6. A presence attribute information server in accordance with claim 4 further comprising a user prompt module, coupled to the expiration module and the interface unit, wherein if the presence attribute information is determined as no longer being current, the user prompt module is adapted to request updated presence attribute information from the user.

7. A presence attribute information server in accordance with claim 6 wherein the prompt module includes a set of prestored instructions for execution by the processor.

8. A presence attribute information server in accordance with claim 1 further comprising a broadcast module, coupled to the interface unit and the storage unit, the broadcast module being adapted to transmit updated user presence attribute information to subscribed users authorized to receive updates, when the presence information changes.

9. A presence attribute information server in accordance with claim 8 wherein the broadcast module includes a set of prestored instructions for execution by the processor.

10. A presence attribute information server in accordance with claim 1 further comprising an authorization module, coupled to the interface unit and the storage unit, adapted for receiving a request for user presence attribute information and the identity of the user requesting the information, the authorization module including a comparator for comparing the identity of the user requesting the information with the identities of one or more users contained within one or more authorization entries associated with the presence attribute entry containing the presence attribute information that is being requested, wherein the authorization module either grants or denies access to the presence attribute information, based upon the identity of the user requesting the information matching the at least one of the identities of the one or more users contained within the one or more associated authorization entries.

11. A presence attribute information server in accordance with claim 10 wherein at least some of the authorization entries contain the identity of users that are expressly permitted to have access to the presence attribute information.

12. A presence attribute information server in accordance with claim 10 wherein at least some of the authorization entries contain the identity of users that are expressly denied access to the presence attribute information.

13. A presence attribute information server in accordance with claim 10 wherein the authorization module includes a set of prestored instructions for execution by the processor.

14. A presence attribute information manager application comprising:
a processor;
an interface unit, coupled to the processor, including a data input device for receiving user attribute information from the user and a network interface for transmitting user presence attribute information;
a storage unit, coupled to the interface unit and the processor, including presence attribute information organized and arranged as one or more entries in a data structure, each presence attribute information entry having an identifier field identifying the type of presence attribute, a presence attribute value field, and a validity period field.

15. A presence attribute information manager application in accordance with claim 14 wherein the validity period field includes a validity duration and an indication of when the presence attribute value field was last changed.

16. A presence attribute information manager application in accordance with claim 14 wherein the validity period field includes a time value corresponding to when information contained within the presence attribute value field is no longer current.

17. A presence attribute information manager application in accordance with claim 14 further comprising an expiration module, coupled to the storage unit, the expiration module including a clock, which maintains the value of the current time, the expiration module being adapted to compare the value of the current time with the value of the validity period field to determine if the presence attribute information is current, and, if necessary, updates the presence attribute value field.

18. A presence attribute information manager application in accordance with claim 17 wherein the expiration module includes a set of prestored instructions for execution by the processor.

19. A presence attribute information manager application in accordance with claim 17 further comprising a user prompt module, coupled to the expiration module and the interface unit, wherein if the presence attribute information is determined as no longer being current, the user prompt module is adapted to request updated presence attribute information from the user.

20. A presence attribute information manager application in accordance with claim 19 wherein the prompt module includes a set of prestored instructions for execution by the processor.

21. A presence attribute information manager server in accordance with claim 14 further comprising a broadcast module, coupled to the interface unit and the storage unit, the broadcast module being adapted to transmit updated user presence attribute information to at least one of a presence attribute information server and subscribed users, that are authorized to receive updates, when the presence information changes.

22. A presence attribute information manager server in accordance with claim 21 wherein the broadcast module includes a set of prestored instructions for execution by the processor.

23. A presence attribute information manager application in accordance with claim 14 wherein the presence attribute information manager application is incorporated as part of a portable electronic device.

24. A presence attribute information manager application in accordance with claim 23 wherein the portable electronic device is a wireless radio frequency telephone.

25. A method for managing a validity period in association with a presence attribute comprising:
receiving a user presence attribute information entry including an identifier field identifying the type of presence attribute, a presence attribute value field, and a validity period field;
determining a time value when the information contained within the presence attribute value field is no longer current;
comparing the time value to the current time; and
updating the value of the presence attribute if the current time is after the determined time value when the information contained within the presence attribute value field is no longer current.

26. A method in accordance with claim 25 wherein updating the value of the presence attribute includes prompting the user for updated presence attribute information and updating the presence attribute information, if new user presence attribute information is received.

27. A method in accordance with claim 25 wherein updating the value of the presence attribute includes identifying the validity of the presence attribute information as having expired if the presence attribute information is no longer current.

28. A method in accordance with claim 25 wherein receiving a user presence attribute information entry includes broadcasting the user presence attribute information to at least one of a presence attribute information manager server and subscribed users, that are authorized to receive updates.

29. A method in accordance with claim 25 further comprising receiving a request for a user's presence attribute information from another user, comparing the identity of the other user to a list of users authorized to receive the requested user's presence attribute information.
